(19) United States
(12) Patent Application Publication
(10) Pub. No.: US 2016/0274845 A1
(43) Pub. Date: Sep. 22, 2016

(54) PRINT CONTROL APPARATUS AND COMPUTER-READABLE RECORDING MEDIUM

(71) Applicant: SEIKO EPSON CORPORATION, Tokyo (JP)

(72) Inventors: Tetsuya WAKASA, Sapporo (JP); Hiroyasu OGATA, Sapporo (JP)

(21) Appl. No.: 14/937,023

(22) Filed: Nov. 10, 2015

(30) Foreign Application Priority Data
Mar. 20, 2015 (JP) 2015-058009

(51) Int. Cl. G06F 3/12; B41J 29/38

(52) U.S. Cl. CPC G06F 3/1254; G06F 3/1231; G06F 3/1287; B41J 29/38

(57) ABSTRACT

A print control apparatus includes a communication unit that communicates with the printer, a communication controller that makes a transmission request for a transmission command while taking the printer as a transmission target, a storage unit, a transmission controller that transmits the transmission command to the printer through the communication unit in response to the transmission request, and a reception controller that acquires response data corresponding to the transmission command from the printer through the communication unit and stores the acquired response data in a region of the storage unit in accordance with a type of the response data. The communication controller acquires the response data stored in the region of the storage unit, which is determined in accordance with the type of the transmission command, as the response data corresponding to the transmission command.

### CROSS REFERENCES TO RELATED APPLICATIONS

This application claims priority to Japanese Application No. 2015-058009, filed Mar. 20, 2015, the entirety of which is incorporated by reference herein.

### BACKGROUND

1. Technical Field

The present invention relates to a print control apparatus that controls a printer with a bi-directional communication function as a function of the Version 4 printer driver.

2. Related Art

A terminal operating under an environment of Windows (registered trademark) has a bi-directional communication function (BiDi) for executing bi-directional communication with a device such as a printer. Usage of the bi-directional communication function enables the terminal to transmit a request from an application to the printer and acquire response data from the printer in response to the request through a communication unit.

In the Version 4 printer driver (hereinafter, also referred to as “V4 printer driver”) operating under an environment of Windows 8 or its successors, the bi-directional communication function is defined as an extension function for device control. With the extension function, processing of transmitting a command from the application to the printer and processing of acquiring response data from the printer are executed by different interfaces (IFs) formed by Javascript (registered trademark). For example, in order to transmit the command issued by the application to the printer, a series of processing is executed using a set method of the extension function. On the other hand, in order to acquire the response data from the printer, a series of processing is executed using a get method of the extension function.

An example of related art is given at the following URL: http://msdn.microsoft.com/library/windows/hardware/br259124

In the bi-directional communication function of the V4 printer driver, synchronization between the processing by the set method and the processing by the get method is not made. Therefore, the command transmitted by the set method and the data acquired by the get method do not correspond to each other in some cases.

### SUMMARY

An advantage of some aspects of the invention is to provide a print control apparatus and a print control program capable of suppressing inconsistency between a transmission command and response data in a bi-directional communication function as an extension function of the V4 printer driver.

A print control apparatus according to an aspect of the invention controls a printer with a bi-directional communication function using a communication unit. A “terminal” may be any apparatus such as a personal computer, a tablet terminal, and a smartphone as long as the apparatus includes the V4 printer driver and can control the printer. The “communication unit” is an interface realizing communication between the printer and the print control apparatus and is an interface operating in accordance with the universal serial bus (USB), the transmission control protocol/internet protocol (TCP/IP), infrared communication, or the like.

A communication controller makes a transmission request for transmitting a transmission command generated in a print controller to the printer. The transmission command that is requested to be transmitted by the communication controller includes a transmission command generated by an application installed in the print controller and a transmission command generated by the communication controller.

The transmission controller transmits the transmission command to the printer through the communication unit in response to the transmission request. A reception controller acquires response data corresponding to the transmission command, having been transmitted from the transmission controller, from the printer through the communication unit and stores the acquired response data in a region of a storage unit in accordance with a type of the response data. Herein, the “transmission controller” and the “reception controller” are functions that are realized by the extension function of the V4 printer driver.

The communication controller acquires the response data stored in the region of the storage unit, which is determined in accordance with the type of the transmission command, as the response data corresponding to the transmission command.

In the aspect of the invention configured as described above, the reception controller stores the response data acquired from the printer in the region of the storage unit in accordance with the type of the response data and the communication controller acquires the response data from the corresponding region of the storage unit in accordance with the type of the transmission command. Therefore, acquisition of response data that does not correspond to the transmission command can be suppressed.

### BRIEF DESCRIPTION OF THE DRAWINGS

The invention will be described with reference to the accompanying drawings, wherein like numbers reference like elements

FIG. 1 is a block diagram for explaining the configuration of a print control apparatus as an example.

FIG. 2 is a diagram for explaining functions of software which are realized by a central processing unit (CPU).

FIG. 3 is a diagram schematically illustrating only functions related to bi-directional communication among the functions which are realized by the CPU.

FIG. 4 is a sequence diagram for explaining processing related to transmission of a transmission command in the bi-directional communication.

FIG. 5 is a flowchart for explaining processing that is executed by a high-level communication module at step S2.

FIG. 6 is a sequence diagram for explaining processing executed by respective modules related to reception of response data in the bi-directional communication.

FIG. 7 is a flowchart for explaining processing that is executed by a reception controller at step S13.

FIGS. 8A and 8B are diagrams for explaining positions of response data storage regions.

FIG. 9 is a flowchart for explaining processing that is executed by the high-level communication module at step S15.

FIG. 10 is a diagram for explaining a reference table referred at step S151.

FIGS. 11A and 11B are diagrams for explaining relations between transmission time information and reception time information related to acquisitions of response data carried out in time sequence.

### DESCRIPTION OF EXEMPLARY EMBODIMENTS

Hereinafter, embodiments of the present invention will be described in accordance with the following order.
1. First Embodiment
1.1 Configuration of Print Control Apparatus
1.2 Functional Configuration of Software
1.3 Print Control Method
2. Other Embodiments

### 1. First Embodiment

### 1.1 Configuration of Print Control Apparatus

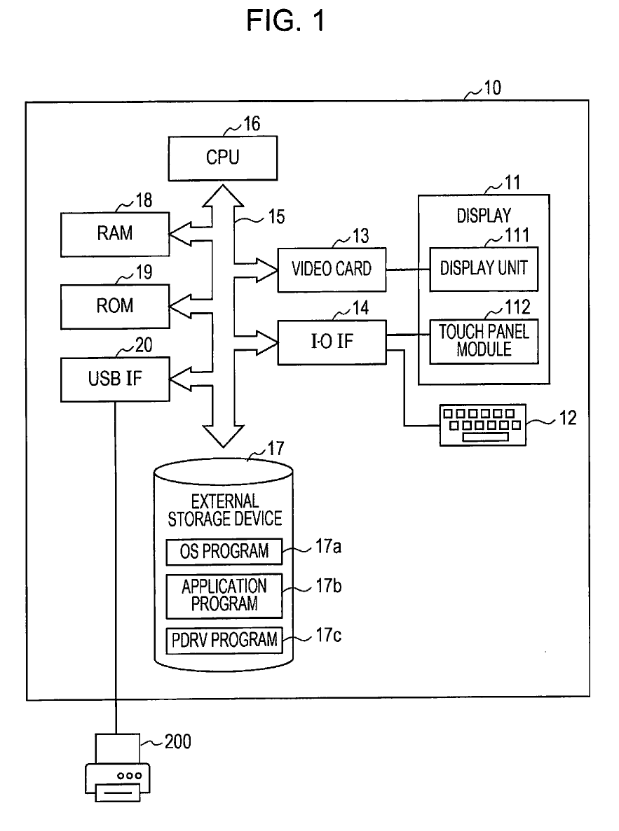

FIG. 1 is a block diagram for explaining the configuration of a print control apparatus as an example. A terminal 10 such as a personal computer will be described as an example of the print control apparatus below. The terminal 10 includes a display 11, an operation key 12, a video card 13, an input/output (I/O) interface (IF) 14, a bus 15, a CPU 16, an external storage device 17, a random access memory (RAM) 18, a read only memory (ROM) 19, and a universal serial bus (USB) IF 20.

The display 11 includes a display unit 111 for displaying an image and a touch panel module 112 for receiving an operation from a user. The display unit 111 includes a liquid crystal display (LCD) and a driver circuit for driving the LCD, for example, and is connected to the video card 13. The video card 13 connects the bus 15 and the display 11. The touch panel module 112 includes a sensor of an electrostatic capacity system or a resistive film system, and outputs a voltage value in accordance with a user operation position to the I/O IF 14.

The operation key 12 is configured by push-in-type buttons and is a user interface receiving an operation by the user.

The I/O IF 14 outputs a signal that is generated based on the operation on the touch panel module 112 or the operation key 12 by the user to the bus 15.

The CPU 16, the external storage device 17, the I/O IF 14, the RAM 18, the ROM 19, the video card 13, and the USB IF 20 are connected to the bus 15. The bus 15 includes a chip set (not illustrated) and controls communication between the CPU 16 and other devices.

The CPU 16 loads a program stored in the external storage device 17 or the ROM 19 on the RAM 18 and executes it so as to control the terminal 10 integrally. A basic input output system (BIOS) program that is executed when the CPU 16 starts the operation is stored in the ROM 19. The RAM 18 functions as a work area on which the program and data that are processed by the CPU 16 are loaded.

The external storage device 17 stores therein an operation system (OS) program 17a for giving a function to the CPU 16 as an OS, an application program 17b for giving functions of applications to the CPU 16, and a printer driver program (PDRV program) 17c controlling a printer 200 in cooperation with the OS. The OS program 17a is Windows 10 (Windows is a registered trademark), for example. The application program 17b allows the CPU 16 to realize the functions of the applications such as drawing software, a PDF file viewer, a browser, and a Web application. The PDRV program 17c is the V4 printer driver and includes an extension function.

The USB IF 20 includes a USB controller and a USB cable, and connects the bus 15 and the printer 200. In the embodiment, the communication unit is configured by the USB IF 20.

The printer 200 is an ink jet printer or a laser printer. The printer 200 conforms to the PDRV program 17c stored in the external storage device 17 and the driving thereof is controlled based on print data or a transmission command that is transmitted from the terminal 10 through the USB IF 20. It should be noted that the internal configuration of the printer 200 is well-known and description thereof is omitted.

### 1.2 Functional Configuration of Software

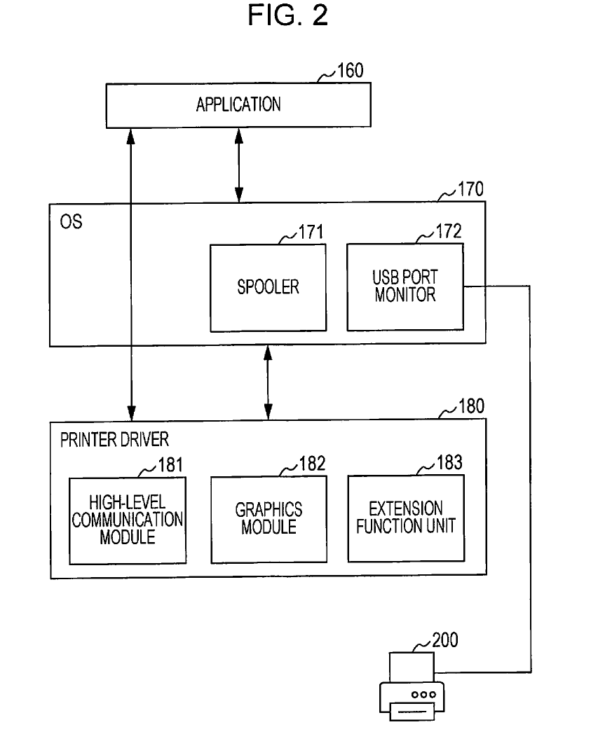

FIG. 2 is a diagram for explaining functions of software which are realized by the CPU 16. In FIG. 2, the functions which are realized by the CPU 16 with the respective programs stored in the external storage device 17 are expressed as an application 160, an OS 170, and a printer driver 180.

The application 160 generates print data containing an image and text. The print data is supposed to be data adapted to the format of XML paper specification (XPS) but may be data adapted to other formats. Further, the application 160 has a function of issuing, to the printer 200, maintenance commands to acquire status information indicating a state of an ink remaining amount or the like and execute processing of cleaning or the like. Hereinafter, the command that is issued by the application 160 is referred to as a transmission command SC.

The OS 170 includes a spooler 171 and a USB port monitor 172 and controls the printer 200 in cooperation with the printer driver 180. The spooler 171 controls output processing of data (spool data) in print processing and transmission and reception of data in bi-directional communication. The USB port monitor 172 manages port numbers that are used by the application 160, the printer driver 180, and so on in communication, and substantially carries out communication using the above port numbers in the print processing and the bi-directional communication.

The printer driver 180 includes a high-level communication module 181, a graphics module 182, and an extension function unit 183. The high-level communication module (communication controller) 181 receives the print data from the application 160, and receives and transmits control data (transmission command SC, response data RD) from and to the application 160. In the print processing, the graphics module 182 converts the print data generated by the application 160 into a format which is supported by the printer 200. The extension function unit 183 is configured by modules for extending functions that are used in the print processing and the bi-directional communication.

The extension function unit 183 includes a plurality of function modules for respective functions. Each function module is configured by a script file formed by Javascript and an extensible markup language (XML) file. The XML file functions as a schema defining each function and the script file operates based on the XML file so as to provide an extended function to the printer driver 180. The respective function modules are made to operate by being called from the spooler 171.

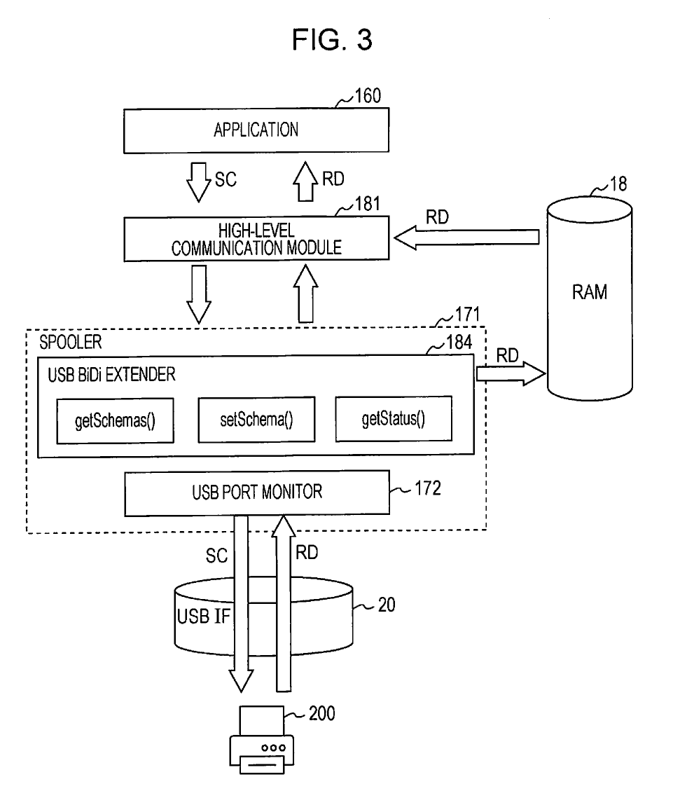

FIG. 3 is a diagram schematically illustrating only the functions related to the bi-directional communication using the USB IF 20 among the functions that are realized by the CPU 16. The spooler 171 calls a USB Bidi Extender 184 among the function modules included in the extension function unit 183, so that the bi-directional communication is executed. SetSchema( ) as a method (function) that is installed in the script file in the USB Bidi Extender 184 realizes a function of transmitting the transmission command SC acquired from the application 160 by the high-level communication module 181 to the printer 200 through the USB IF 20 from the USB port monitor 172. GetSchemas( ) as a method (function) that is installed in the script file realizes a function of acquiring the response data RD that is generated corresponding to the transmission command SC by the printer 200 through the USB IF 20. The response data RD acquired by the getSchemas( ) is stored in an appropriate corresponding region (response data storage region as will be described later) of the RAM 18 which is defined by an element in the XML file. The response data RD stored in the above appropriate corresponding region is acquired by the high-level communication module 181 and is returned to the application 160.

Hereinafter, the function unit that is realized when the terminal 10 (CPU 16) uses the setSchema( ) is also referred to as a transmission controller and the function unit that is realized when the terminal 10 (CPU 16) uses the getSchemas( ) is also referred to as a reception controller.

### 1.3 Print Control Method

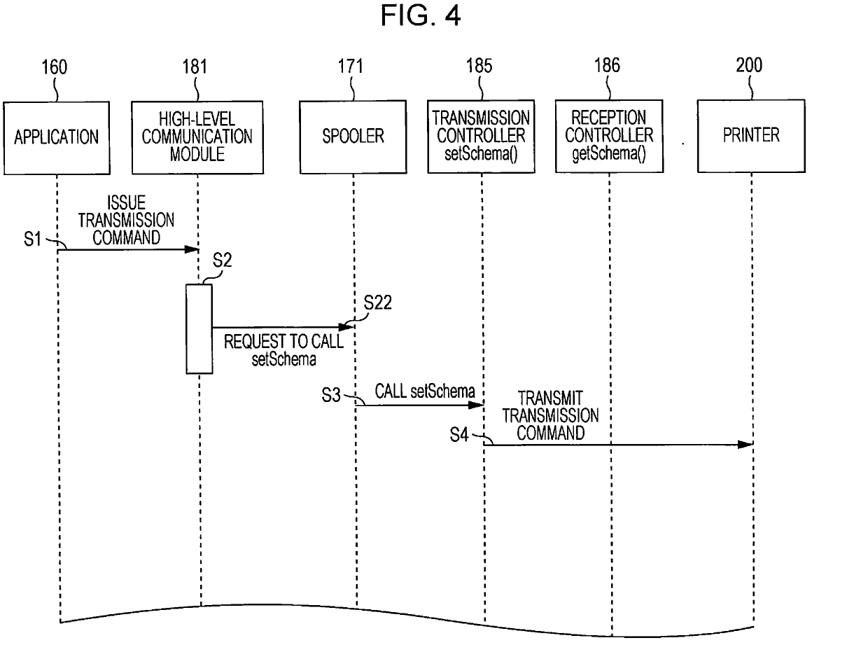

Next, a print control method using the bi-directional communication function will be described. FIG. 4 is a sequence diagram for explaining processing related to transmission of the transmission command in the bi-directional communication. FIG. 4 illustrates processing executed by the application 160, the high-level communication module 181, the spooler 171, a transmission controller 185, a reception controller 186, and the printer 200.

At S1, the application 160 issues, to the printer 200, the transmission command to request status information (response data RD). For example, the status information is information that the application 160 displays on a UI screen indicating the state of the printer 200.

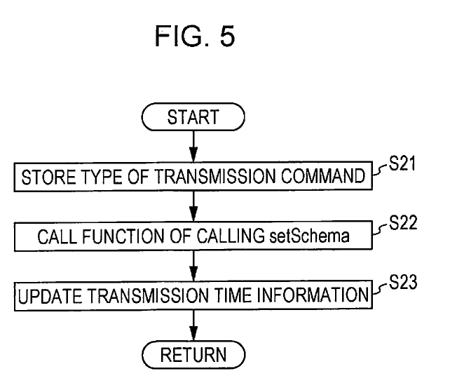

At step S2, the high-level communication module 181 performs processing of transmitting the transmission command to the printer 200. FIG. 5 is a flowchart for explaining the processing that is executed by the high-level communication module 181 at step 2.

At step S21, the high-level communication module 181 stores a type of the transmission command acquired from the application 160. The type of the transmission command is determined based on the contents of processing that are requested by the application 160, such as a request for the status information and a request for execution of the maintenance processing, for example.

At step S22, the high-level communication module 181 calls a function for calling setSchema( ) to the spooler 171. With the function called by the high-level communication module 181, a call request for setSchema( ) of the USB Bidi Extender 184 is made to the spooler 171.

At step S23, the high-level communication module 181 updates transmission time information STI. The transmission time information STI is information indicating time at which the high-level communication module 181 has started processing of transmitting the transmission command to the printer 200.

Returning to FIG. 4, at step S3, the spooler 171 calls setSchema( ) of the USB Bidi Extender 184 with the function called by the high-level communication module 181 and sets the transmission command as an argument of setSchema( ). By setSchema( ) being read out, the CPU 16 functions as the transmission controller 185.

At step S4, the transmission controller 185 controls the USB port monitor 172 and transmits the transmission command to the printer 200. The transmission command is transmitted to the printer 200 through the USB IF 20 with the function of the USB port monitor 172. When the printer 200 receives the transmission command through the USB IF 20, it interprets the transmission command and forms the response data RD corresponding to the transmission command.

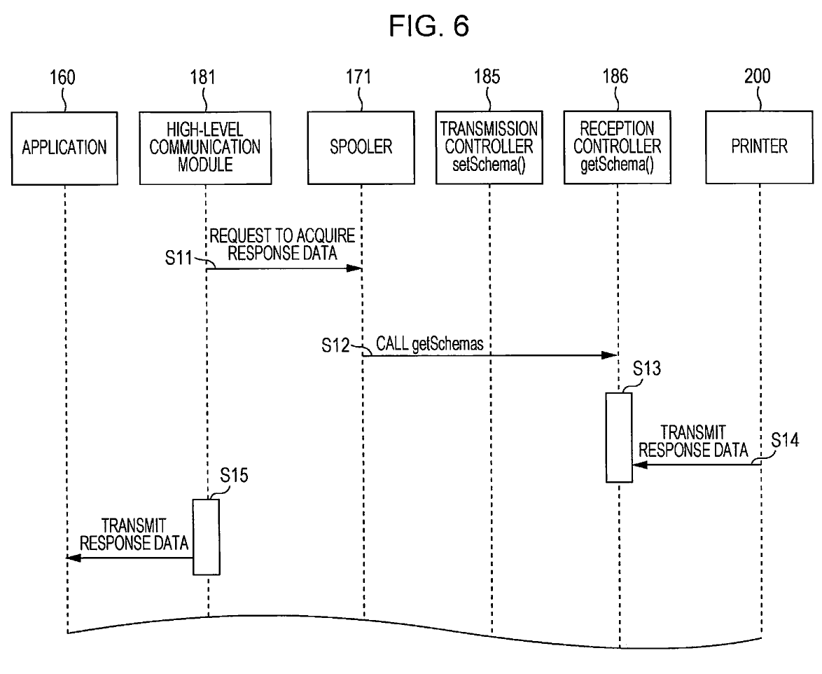

Next, the reception control that is performed in the terminal 10 will be described. FIG. 6 is a sequence diagram for explaining processing executed by respective modules related to reception of the response data RD in the bi-directional communication. FIG. 6 illustrates processing executed by the application 160, the high-level communication module 181, the spooler 171, the transmission controller 185, the reception controller 186, and the printer 200.

When conditions under which the response data RD is requested are satisfied, the high-level communication module 181 makes an acquisition request for the response data RD at step S11. The acquisition request by the high-level communication module 181 is made when the spooler 171 executes the function for calling getSchemas( ).

At step S12, the spooler 171 calls getSchemas( ) from the USB Bidi Extender 184 of the extension function unit 183 in accordance with the function that is executed by the high-level communication module 181. By getSchemas( ) being executed, the CPU 16 functions as the reception controller 186.

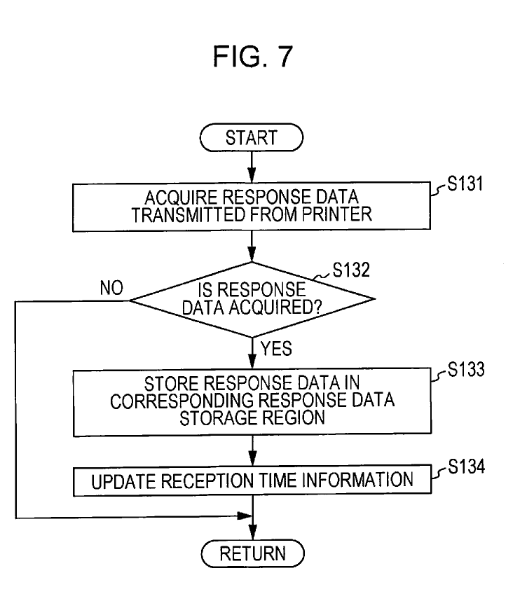

At step S13, the reception controller 186 performs processing of acquiring the response data RD. FIG. 7 is a flowchart for explaining the processing that is executed by the reception controller 186 at step S13.

At step S131, the reception controller 186 acquires the response data RD transmitted from the printer 200 through the USB IF 20 (FIG. 6, step S14).

At step S132, the reception controller 186 determines whether or not it has acquired the response data RD from the printer 200. When the reception controller 186 has acquired the response data RD (YES; at step S132), the reception controller 186 stores the received response data RD in the corresponding storage region (response data storage region) of the RAM 18 at step S133. The address of the response data storage region in which the reception controller 186 stores the response data RD is defined in the XML file of the extension function unit 183.

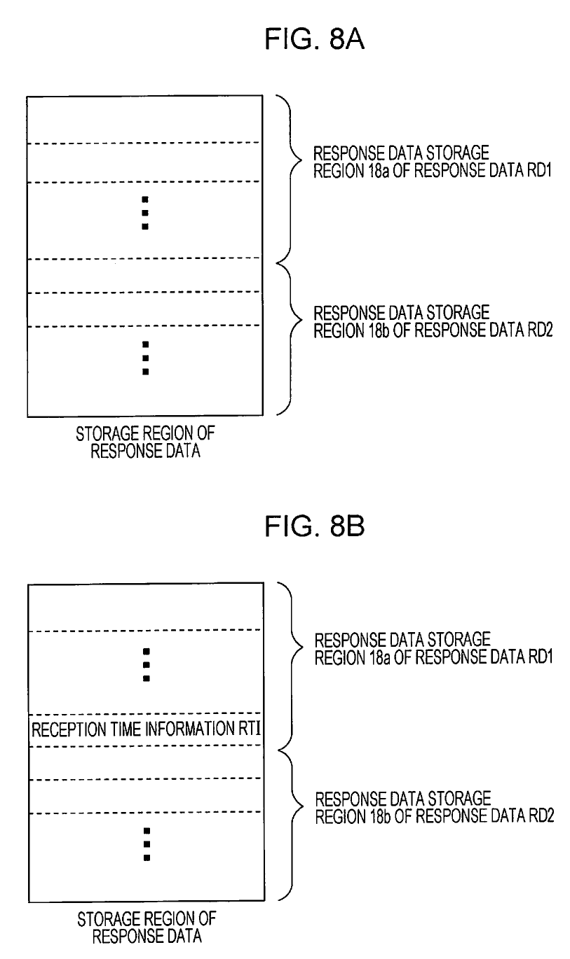

FIGS. 8A and 8B are diagrams for explaining positions of the response data storage regions. The response data storage region is specified in the XML file in accordance with the type of the response data RD. In FIG. 8A, in the storage region of the RAM 18, the response data storage region of response data RD1 corresponding to a transmission command SC1 is a region 18a, and the response data storage region of response data RD2 corresponding to a transmission command SCB is a region 18b.

At step S134, the reception controller 186 updates reception time information RTI. The reception time information RTI is information indicating time at which the terminal 10 has acquired the response data RD. In FIG. 8B, the reception controller 186 stores the reception time information RTI in the response data storage region in which the corresponding response data RD (response data RD1 in FIG. 8B) is stored so as to update the reception time information RTI.

On the other hand, at step S132, when the reception controller 186 has not acquired the response data RD from the printer 200 (NO; at step S132), the reception controller 186 finishes the processing without executing the processing at step S133 and S134. In this case, the corresponding response data storage region in the RAM 18 is not updated.

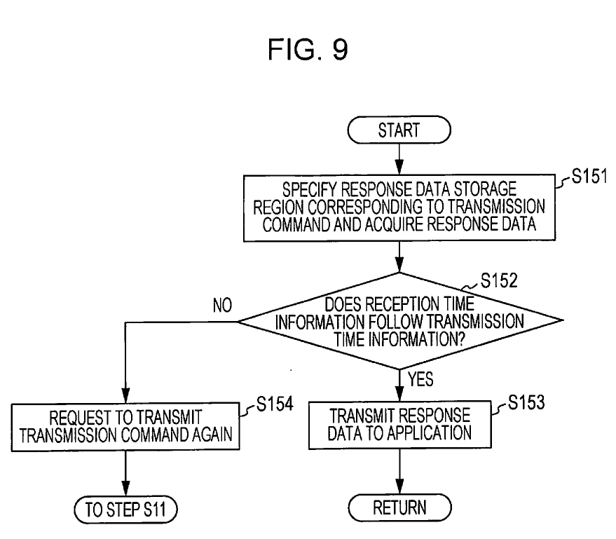

Returning to FIG. 6, at step S15, the high-level communication module 181 performs processing of acquiring the response data RD. FIG. 9 is a flowchart for explaining the processing that is executed by the high-level communication module 181 at step S15.

At step 151 in FIG. 9, the high-level communication module 181 specifies a response data storage region as a reference destination in which the response data RD is stored in accordance with the type of the transmission command SC (transmission command SC stored at step S21) and acquires the response data RD from the specified response data storage region. The determination of the response data storage region as the reference destination is performed using a reference table RT stored in the extension function unit 183, for example.

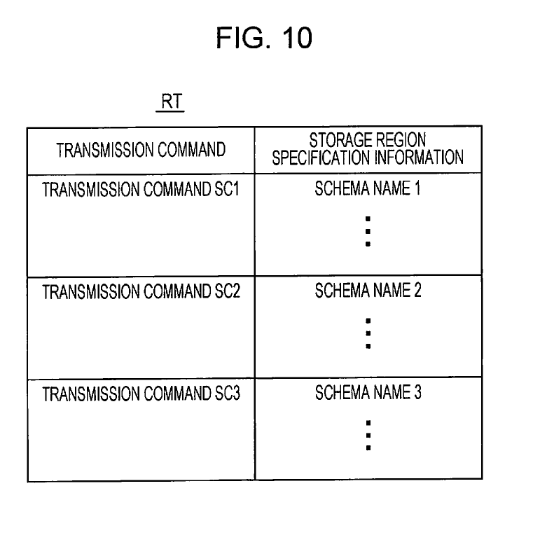

FIG. 10 is a diagram for explaining the reference table RT that is referred at step S151. In the reference table RT, storage region specification information with which the response data storage region as the reference destination can be specified is stored for each type of the transmission command SC. As the storage region specification information, for example, a schema name defining the response data storage region as the reference destination in the XML file, a definition name indirectly indicating the response data storage region in the XML file, or the like can be used. Alternatively, a leading address or the like of the response data storage region may be used. The high-level communication module 181 acquires the storage region specification information of the response data storage region from the reference table RT based on the type of the transmission command SC stored at step S111 and acquires the response data RD from the response data storage region corresponding to the storage region specification information.

At step S152, the high-level communication module 181 compares the transmission time information STI and the reception time information RTI. In the first embodiment, the high-level communication module 181 checks the response data using the transmission time information STI and the reception time information RTI in addition to the response data storage region provided for each response data. With this, inconsistency between the transmission command SC and the response data RD, that is, understanding the wrong response data RD as response data corresponding to the transmitted transmission command is suppressed.

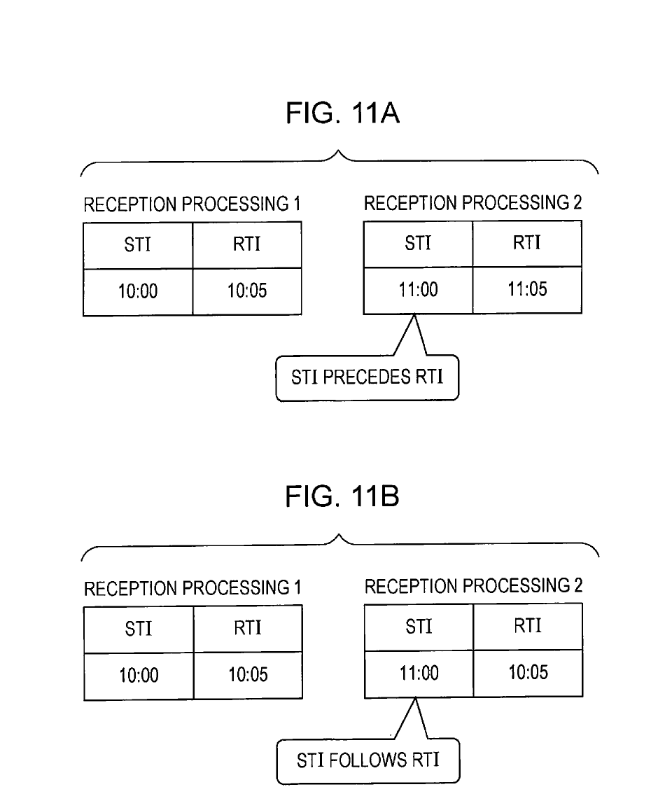

FIGS. 11A and 11B are diagrams for explaining relations between the transmission time information STI and the reception time information RTI related to acquisitions of response data carried out in time sequence. FIG. 11A illustrates examples of the transmission time information STI and the reception time information RTI of the response data RD appropriately acquired in a preceding acquisition of the response data RD (reception processing 1) and the response data RD appropriately acquired in a following acquisition thereof (reception processing 2). FIG. 11B illustrates examples of the transmission time information STI and the reception time information RTI in the case where the response data RD was not acquired in the above following acquisition of the response data RD (reception processing 2). In both of FIGS. 11A and 11B, it is assumed that the transmission command SC is transmitted at the same time (STI) in the transmission processing.

In FIG. 11A, the reception time information RTI is updated by the acquisition of the response data RD in the reception processing 2, and the transmission time information STI indicates time preceding (earlier than) time indicated by the reception time information RTI. On the other hand, in FIG. 11B, the reception time information RTI has not been updated because the response data RD was not acquired in the reception processing 2, and the transmission time information STI indicates time following time indicated by the reception time information RTI.

When the transmission time information STI precedes (is earlier than) the reception time information RTI (YES; at step S152), at step S153, the high-level communication module 181 determines that the appropriate response data RD has been received because the transmission time and the reception time are consistent in time series, and then transmits the response data RD to the application 160 for the following reason. That is, when time indicated by the transmission time information STI precedes (is earlier than) time indicated by the reception time information RTI, as illustrated in FIG. 11A, the response data RD in the corresponding response data storage region has been updated and the response data RD can be determined to correspond to the transmission command SC transmitted previously.

When the transmission time information STI follows (is closer to the current time than) the reception time information RTI (NO; at step S152), at step S154, the high-level communication module 181 determines that the appropriate response data RD has not been received because the transmission time and the reception time are not consistent in time series, and issues a request for the response data RD to the spooler 171 again for the following reason. That is, when time indicated by the transmission time information STI follows (is closer to the current time than) time indicated by the reception time information RTI, as illustrated in FIG. 11B, the response data RD in the corresponding response data storage region has not been updated and the response data RD does not correspond to the transmission command SC. The re-request for the response data RD at step S154 causes the processing at step S11 in FIG. 6 to be executed and the spooler 171 calls getSchemas( ).

In the first embodiment as described above, in the terminal (print control apparatus) 10 having the bi-directional communication function of the V4 printer driver, the reception controller 186 stores the response data RD that is acquired from the printer 200 in the response data storage region in the RAM 18 in accordance with the type thereof. Then, the high-level communication module (communication controller) 181 acquires the response data from the corresponding response data storage region in accordance with the type of the transmission command SC.

For example, in the case where the response data RD corresponding to the transmission command SC transmitted previously could not be acquired from the printer 200, or in the case where reading out, rewriting, or the like of data defined in the XML file is performed in the OS 170, correspondence between the transmission command SC and the response data RD can be kept appropriately by providing the response data storage region for each response data. As a result, the high-level communication module 181 can suppress acquisition of the response data RD that does not correspond to the transmission command SC.

The high-level communication module 181 holds the transmission time information indicating time at which the transmission request for the transmission command SC has been made and the reception controller 186 stores the reception time information indicating time at which the response data has been acquired in the storage unit. Then, the high-level communication module 181 determines whether or not the response data stored in the response data storage region corresponds to the transmission command SC based on the reception time information and the transmission time information, thereby strictly suppressing the wrong acquisition of response data that does not correspond to the transmission command SC.

### 2. Other Embodiments

Usage of the USB IF as the communication unit is merely an example, and the communication unit may be an interface with which the printer and the host device makes one-to-one communication such as infrared communication and IEEE1394.

The terminal may be any devices such as a tablet terminal and a smartphone other than the personal computer as long as it includes the V4 printer driver and can control the printer.

It is needless to say that the invention is not limited to the above-mentioned embodiments. It is obvious to those skilled in the art to combine, change, or modify the following configurations, parts, and so on: Parts, configurations, and the like as disclosed in the above-mentioned embodiments, which can be replaced by one another, being applied while combinations thereof are changed appropriately;

Parts, configurations, and the like that are not disclosed in the above-mentioned embodiments but are well-known techniques and can be made replacement between them and the parts, the configurations, and the like as disclosed in the above-mentioned embodiments being applied while appropriately replacing them or changing combinations thereof; and

Parts, configurations, and the like that are not disclosed in the above-mentioned embodiments but can be conceived as substitutions for the parts, the configurations, and the like as disclosed in the above-mentioned embodiments by those skilled in the art based on well-known techniques and the like being applied while replacing them or changing combinations thereof.

What is claimed is:

1. A print control apparatus controlling a printer using a bi-directional communication function, the apparatus comprising:
a communication unit that communicates with the printer;
a communication controller that makes a transmission request for a transmission command while taking the printer as a transmission target;
a storage unit;
a transmission controller that transmits the transmission command to the printer through the communication unit in response to the transmission request; and
a reception controller that acquires response data corresponding to the transmission command from the printer through the communication unit and stores the acquired response data in a region of the storage unit in accordance with a type of the response data,
wherein the communication controller acquires the response data stored in the region of the storage unit, which is determined in accordance with the type of the transmission command, as the response data corresponding to the transmission command.

2. The print control apparatus according to claim 1,
wherein the communication controller holds transmission time information indicating time at which the transmission request for the transmission command has been made,
the reception controller stores reception time information indicating time at which the response data has been acquired in the storage unit, and
the communication controller determines whether or not the response data stored in the region of the storage unit corresponds to the transmission command based on the reception time information and the transmission time information.

3. The print control apparatus according to claim 2,
wherein the communication controller determines that the response data stored in the region of the storage unit corresponds to the transmission command when the transmission time information indicates time earlier than time indicated by the reception time information.

4. The print control apparatus according to claim 2,
wherein the communication controller makes the transmission request for the transmission command again when the reception time information indicates time earlier than time indicated by the transmission time information.

5. The print control apparatus according to claim 1,
wherein the communication unit is an interface in accordance with USB standards.

6. The print control apparatus according to claim 1, further comprising:
a spooler that calls an extension function in response to a request from the communication controller,
wherein the transmission controller and the reception controller are read out by the spooler and executed.

7. A computer-readable recording medium storing a print control program that causes a computer to control a printer using bi-directional communication, the print control program causing the computer to implement:
a communication control function of making a transmission request for a transmission command while the printer is taken as a transmission target;
a transmission control function of transmitting the transmission command to the printer through a communication unit in response to the transmission request; and
a reception control function of acquiring response data corresponding to the transmission command from the printer through the communication unit and storing the acquired response data in a region of a storage unit in accordance with a type of the response data,
wherein the communication control function acquires the response data stored in the region of the storage unit, which is determined in accordance with the type of the transmission command, as the response data corresponding to the transmission command.
